(19) United States
(12) Patent Application Publication
(10) Pub. No.: US 2016/0033948 A1
(43) Pub. Date: Feb. 4, 2016

(54) CONTROL SYSTEM

(71) Applicant: Pioneer Corporation, Kawasaki-shi, Kanagawa (JP)

(72) Inventor: Masahiro OKAMURA, Kawasaki-shi, Kanagawa (JP)

(21) Appl. No.: 14/772,168

(22) PCT Filed: Mar. 7, 2013
(86) PCT No.: PCT/JP2013/056347

§ 371 Date: Sep. 2, 2015

(51) Int. Cl. G05B 15/02

(52) U.S. Cl. CPC G05B 15/02

(57) ABSTRACT

A plurality of pieces of candidate information capable of serving as device identification information are divided into a plurality of groups in advance. Each of the plurality of groups is provided with group identification information. A master control unit sequentially outputs pieces of group identification information to a signal line. When group identification information of a belonging group of a device flows through the signal line, a control unit of the device outputs device identification information, stored by the control unit, to the signal line. In this case, a control unit outputs the device identification information after the group identification information is received and then a standby time has elapsed. The standby time is set on the basis of the order of the device identification information of the device within a belonging group. The master control unit provides an address to the received device identification information.

### TECHNICAL FIELD

The present invention relates to a control system that controls a device.

### BACKGROUND ART

A plurality of panel-shaped light-emitting sources such as an organic EL (organic electroluminescence) panel or an LED (Light Emitting Diode) panel may be arranged side by side, and be used as one light-emitting device. In such a light-emitting device, a plurality of light-emitting sources are controlled, and thus it is possible to perform illumination in various forms.

On the other hand, standards for performing control of the light-emitting device include a DMX512-A standard. In the DMX512-A standard, the light-emitting device is constituted by a master control unit for controlling a plurality of light-emitting sources, and a slave unit including the light-emitting sources and control units. The master control unit transmits a command including control data to the slave unit through a communication line. The control unit included in the slave unit controls the light-emitting source in accordance with the control data included in the command.

Meanwhile, Patent Document 1 discloses the following technique with respect to an illumination device for guidance. A control device includes a master control panel and a plurality of control units. The plurality of control units are connected in series to the master control panel. A plurality of illumination apparatuses are connected in series to each of the plurality of control units.

### RELATED DOCUMENT

### Patent Document

[Patent Document 1] Japanese Unexamined Patent Application Publication No. 10-188159

### SUMMARY OF THE INVENTION

When devices are attempted to be controlled in, for example, a DMX512-A standard, it is necessary to set addresses in the devices. However, when the number of devices becomes larger, it becomes difficult to manually set addresses of the devices.

Consequently, the inventor has examined setting of an address of a device, using device identification information which is provided to the device. For example, a method is considered in which information capable of serving as device identification information is output from the master control unit to the device, causing the device including the information as device identification information to respond. However, the number of pieces of information capable of serving as device identification information is large. For this reason, in the above-described method, a time required for a process of setting an address lengthens.

A problem that the invention is to solve includes an example in which a system is able to set an address of a device in a short period of time.

According to the present invention of claim 1, there is provided a control system including a plurality of devices, and a master control unit that generates control data for the plurality of devices. Each of the plurality of devices is provided with device identification information, in advance, selected from a plurality of pieces of candidate information capable of serving as identification information so as to be different from each other. The plurality of pieces of candidate information are divided into a plurality of groups in advance. Each of the plurality of groups is provided with group identification information in advance. The master control unit includes a group identification information output unit that outputs the plurality of pieces of group identification information sequentially, at intervals of time, to the plurality of devices. Each of the devices includes a device identification information storage unit that stores the device identification information of the device, a specific information storage unit that stores belonging group specification information for specifying the group identification information of a belonging group which is the group including the device identification information of the device, from the device identification information of the device, a group determination unit that determines whether the group identification information which is output from the master control unit corresponds to the belonging group on the basis of the device identification information and the belonging group specification information of the device, and a device identification information output unit that outputs the device identification information to the master control unit, after elapse of standby time which is set on the basis of the order of the device identification information of the device within the belonging group, when the group identification information which is output from the master control unit corresponds to the belonging group. The master control unit further includes an address providing unit that provides addresses different from each other to the device identification information which are transmitted from each of the plurality of devices, an address storage unit that stores the plurality of pieces of device identification information in association with the addresses, and an address output unit that outputs the device identification information and the address to each of the devices in association with each other. Each of the devices further includes an address setting unit that performs, when the address is transmitted in association with the device identification information which is stored by the device identification information storage unit of the device, a process of storing the address.

### BRIEF DESCRIPTION OF THE DRAWINGS

The above-mentioned objects, other objects, features and advantages will be made clearer from the preferred embodiments described below, and the following accompanying drawings.

FIG. 1 is a block diagram illustrating a configuration of a control system according to an embodiment.

FIG. 2 is a diagram illustrating a functional configuration of a master control unit.

FIG. 3 is a diagram illustrating a functional configuration of a control unit.

FIG. 4 is a diagram illustrating an example of a configuration of data which is used in communication between a master control unit and a device.

FIG. 5 is a diagram illustrating a specific example of the data shown in FIG. 4(a).

FIG. 6 is a diagram illustrating a specific example of the data shown in FIG. 4(b).

FIG. 7 is a flow diagram illustrating an example of an operation of the control system shown in FIG. 1.

FIG. 8 is a diagram illustrating a functional configuration of a master control unit according to Example 1.

FIG. 9 is a flow diagram illustrating an operation of a control system according to Example 1.

FIG. 10 is a diagram illustrating a functional configuration of a master control unit according to Example 2.

FIG. 11 is a flow diagram illustrating an operation of a control system according to Example 2.

FIG. 12 is a flow diagram illustrating an operation of a control system according to Example 3.

### DESCRIPTION OF EMBODIMENTS

Hereinafter, embodiments of the present invention will be described with reference to the accompanying drawings. In all the drawings, like elements are referenced by like reference numerals and the descriptions thereof will not be repeated.

Meanwhile, in the following description, each component of each control unit represents a function-based block rather than a hardware-based configuration. Each of these components is embodied by any combination of hardware and software with a focus on a CPU, a memory, a program loaded into the memory, storage media such as a hard disk which stores the program, and an interface for network connection of any computer. Embodying methods and devices thereof may be modified in various ways.

### Embodiment

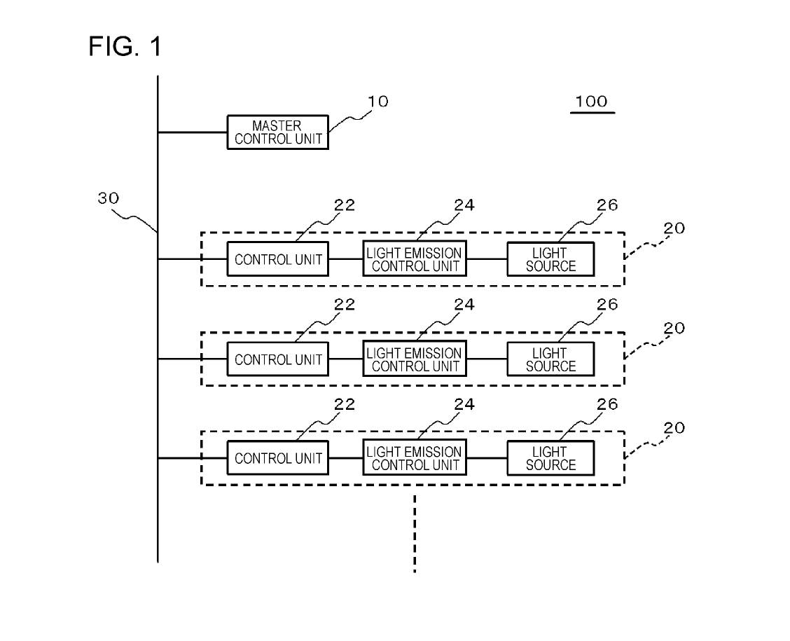

FIG. 1 is a block diagram illustrating a configuration of a control system 100 according to an embodiment. The control system 100 according to the embodiment includes a master control unit 10, a plurality of devices 20, and a signal line 30. The master control unit 10 generates control data for the plurality of devices 20. This control data is output through the signal line 30. The plurality of devices 20 are connected to the signal line 30.

Each of a plurality of devices 20 is provided with device identification information in advance. The device identification information is information which is selected from a plurality of pieces of candidate information (for example, the number of plural digits or the combination of digits and character strings) capable of serving as identification information so as to be different from each other. The device identification information is, for example, a serial number, and is provided at the time of the shipment of each of the devices 20.

The plurality of pieces of candidate information are divided into a plurality of groups in advance. Each of the plurality of groups is provided with group identification information in advance. For example, when the device identification information is a serial number, and the number of pieces of candidate information belonging to each group is set to N, the group identification information of a group (hereinafter, described as a belonging group) to which each of the devices 20 belongs is the quotient when the device identification information of the device 20 is divided by N.

Every device 20 includes a control unit 22. The control unit 22 controls communication between the device 20 and the master control unit 10. A function of the control unit 22 will be described later.

In an example shown in the drawing, the device 20 is a light-emitting module. Hereinafter, a description will be given in which the device 20 is a light-emitting module. However, the device 20 may be a device other than a light-emitting module. The device 20 includes a light emission control unit 24 and a light source 26 in addition to the control unit 22.

The light source 26 is, for example, an organic EL or an LED. However, the light source 26 may be another light source. In addition, the light source 26 is, for example, a panel-shaped light source, but may not be panel-shaped.

The light emission control unit 24 controls the light source 26. Specifically, the light emission control unit 24 controls the light source 26 in accordance with control data which has been transmitted from the master control unit 10 through the signal line 30.

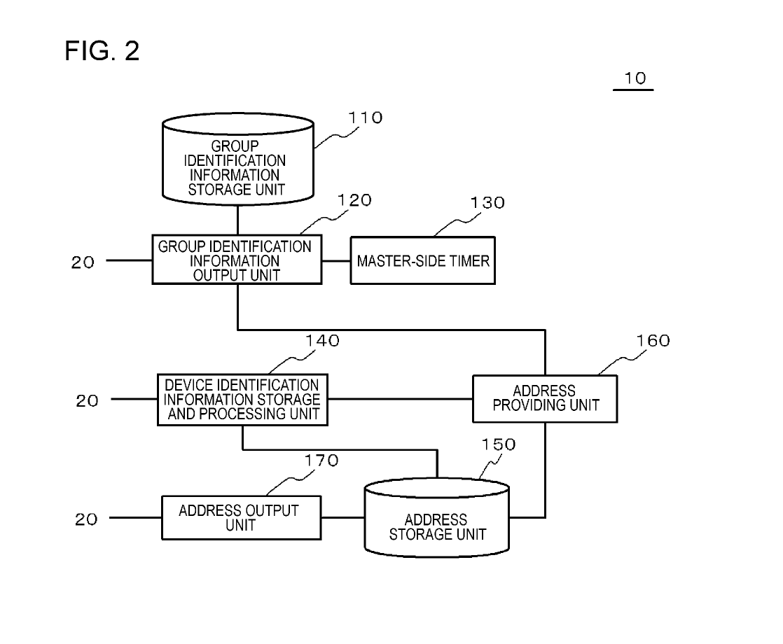

FIG. 2 is a diagram illustrating a functional configuration of the master control unit 10. The master control unit 10 includes a group identification information output unit 120, an address storage unit 150, an address providing unit 160, and an address output unit 170.

The group identification information output unit 120 outputs a plurality of pieces of group identification information sequentially, at intervals of time, to the plurality of devices 20 through the signal line 30. Each of the plurality of devices 20 outputs the device identification information of the device 20 to the master control unit 10 through the signal line 30, as described later, when group identification information corresponding to a group including the device identification information of the device 20 is transmitted.

The address providing unit 160 associates the device identification information, which has been transmitted from each of the plurality of devices 20, with addresses different from each other. The address storage unit 150 stores a plurality of pieces of device identification information in association with the addresses. The addresses are used when the master control unit 10 controls light emission of the light source 26.

The address output unit 170 then outputs an address of the address storage unit 150 to the device 20 through the signal line 30 in association with device identification information corresponding to the address.

In an example shown in the drawing, the master control unit 10 further includes a group identification information storage unit 110, a master-side timer 130, and a device identification information storage and processing unit 140.

The group identification information storage unit 110 stores group specification information. The group specification information is information for recognizing group identification information of each group, and a function for calculating group identification information or the group identification information itself. The group identification information output unit 120 recognizes a plurality of pieces of group identification information on the basis of information stored by the group identification information storage unit 110.

The master-side timer 130 counts a time after the group identification information output unit 120 outputs the group identification information. When the count value of the master-side timer 130 becomes a preset time, the group identification information output unit 120 outputs the next group identification information, and initializes the count value of the master-side timer 130.

The device identification information storage and processing unit 140 stores the device identification information, which has been transmitted from the device 20, in the address storage unit 150.

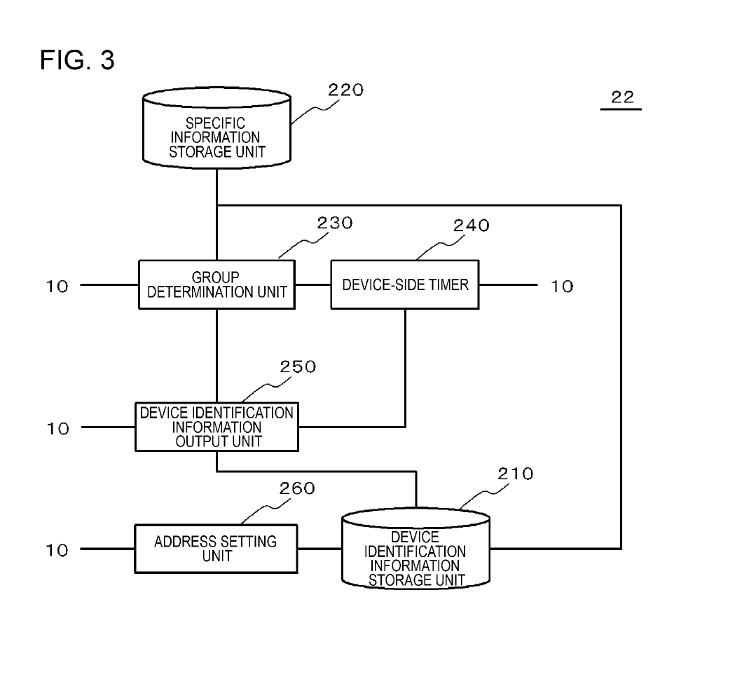

FIG. 3 is a diagram illustrating a functional configuration of the control unit 22. The control unit 22 includes a device identification information storage unit 210, a specific information storage unit 220, a group determination unit 230, a device identification information output unit 250, and an address setting unit 260.

The device identification information storage unit 210 stores the device identification information of the device 20. In addition, the device identification information storage unit 210 stores an address which has been transmitted from the master control unit 10 to the device 20.

The specific information storage unit 220 stores information (hereinafter, described as belonging group specification information) for specifying the group identification information of the belonging group of the device 20 from the device identification information of the device 20. For example, when the device specification information is a serial number, and the group identification information of the belonging group is the quotient when the device identification information is divided by N, the belonging group specification information stores N.

The group determination unit 230 calculates the group identification information of the belonging group on the basis of the device identification information and the belonging group specification information of the device 20. The group determination unit 230 determines whether the group identification information which is output from the master control unit 10 corresponds to the belonging group.

When the group identification information which is output from the master control unit 10 corresponds to the belonging group, the device identification information output unit 250 outputs the device identification information to the master control unit 10 after the group determination unit 230 receives the group identification information and then a standby time has elapses. The standby time is set on the basis of the order of the device identification information of the device 20 within the belonging group. When the device identification information is a serial number, the standby time is a time, for example, obtained by multiplying a constant and the remainder when the device identification information of a corresponding device 20 is divided by N together.

In addition, the control unit 22 further includes a device-side timer 240. When the group determination unit 230 receives the group identification information of the belonging group, the device-side timer 240 initializes a count value and then starts to count.

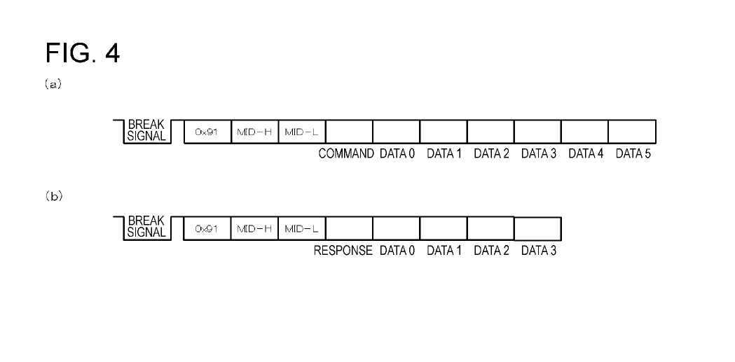

FIG. 4 is a diagram illustrating an example of a configuration of data which is used in communication between the master control unit 10 and the device 20. The configuration of the data shown in the drawing is based on a DMX512-A standard. In DMX512-A, an EIA-485 standard (RS-485 standard) is adopted as the electrical specification of a communication line. Therefore, the communication between the master control unit 10 and the device 20 is asynchronous serial communication. The format of the data is constituted by a 1-byte start code and a subsequent 512-byte data portion after a start signal called a break signal.

As the start code, a null command is used when a variety of controls such as illumination control is performed. On the other hand, when an independent command is used, “0x91” is used as the start code. In this case, as shown in each drawing of FIG. 4, MID (MID-H, MID-L), called Manufacture ID, for identifying a company or organization is used in the next 2 bytes of the start code. An independent command and data are then transmitted using the remaining 510 bytes.

FIG. 4(a) shows a format of data which is transmitted from the master control unit 10 to the device 20. In the next byte of MID, a command is transmitted. In bytes subsequent to the command, required information is transmitted. The command includes an address automatic setting mode start command, an address automatic setting mode termination command, a device identification information response request command, an address setting command, and a count resumption instruction command.

The address automatic setting mode start command is a command for transmitting the start of a mode in which an address is automatically set, to the device 20. The address automatic setting mode termination command is a command for transmitting the termination of a mode in which an address is automatically set, to the device 20. The device identification information response request command is a command which is used together with group identification information, and is a command for requesting device identification information from a device 20 belonging to a group indicated by the group identification information. The address setting command is a command which is used together with device identification information and an address corresponding to the device identification information, and is a command for requesting the device 20 having the device identification information to set the address.

FIG. 4 (b) is a format of data which is transmitted from the device 20 to the master control unit 10. In the next byte of MID, a device identification information transmission command is transmitted. The device identification information transmission command is, for example, a command for identifying a response from a device 20. In addition, in bytes subsequent to the command, the device identification information of the device 20 is transmitted.

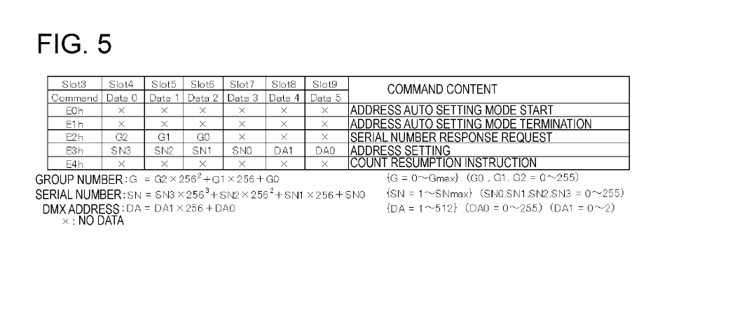

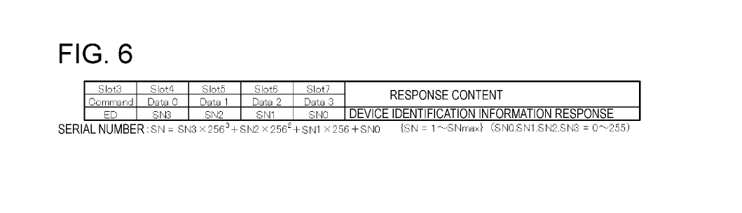

Meanwhile, the specific example of the data shown in FIG. 4(a) is shown in FIG. 5. In addition, the specific example of the data shown in FIG. 4(b) is shown in FIG. 6.

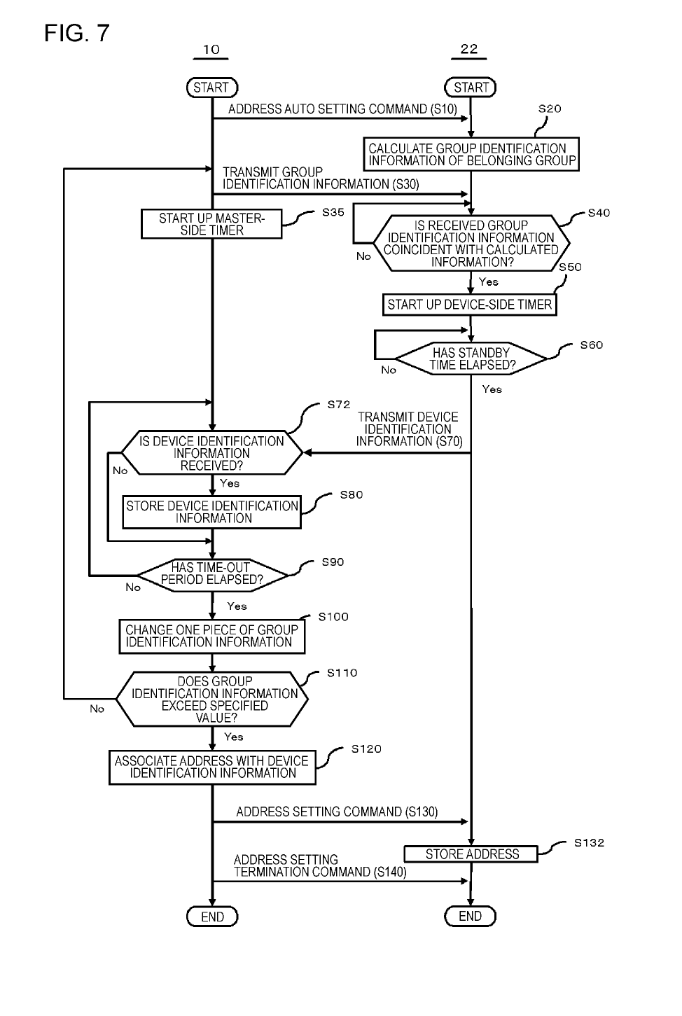

FIG. 7 is a flow diagram illustrating an example of an operation of the control system 100 shown in FIG. 1. First, the group identification information output unit 120 of the master control unit 10 outputs the address automatic setting mode start command to the signal line 30 (step S10). When the address automatic setting mode start command is received, the group determination unit 230 of the control unit 22 of the device 20 calculates the group identification information of the belonging group of the device 20, using the belonging group specification information which is stored by the specific information storage unit 220 and the device identification information which is stored by the device identification information storage unit 210 (step S20). In this case, the group determination unit 230 also calculates a standby time until the device identification information is output.

The group identification information output unit 120 then outputs the group identification information sequentially to the signal line 30, together with the device identification information response request command (step S30). When this output is performed, the master-side timer 130 initializes a count value and then performs counting (step S35).

The group determination unit 230 of the control unit 22 receives the group identification information which is output to the signal line 30, and determines whether the information is coincident with the group identification information of the belonging group which is calculated in step S20 (step S40). When the two pieces of information are coincident with each other (step S40: Yes), the group determination unit 230 starts up the device-side timer 240 (step S50), and outputs a command for outputting the device identification information to the signal line 30, to the device identification information output unit 250.

When the command is received from the group determination unit 230, the device identification information output unit 250 observes whether the count value of the device-side timer 240 is coincident with the standby time calculated by the group determination unit 230 (step S60). When the count value of the device-side timer 240 is coincident with the standby time (step S60: Yes), the device identification information which is stored by the device identification information storage unit 210 is output to the signal line 30 together with the device identification information transmission command (step S70).

When the device identification information is output to the signal line 30 together with the device identification information transmission command, the device identification information storage and processing unit 140 of the master control unit 10 receives the device identification information (step S72), and stores the received device identification information in the address storage unit 150 (step S80). When the count value of the master-side timer 130 becomes a preset value (time-out period) (step S90: Yes), the group identification information output unit 120 changes the group identification information to the next value (step S100). The group identification information output unit 120 compares the group identification information after the value is changed with the number of groups (for example, quotient when the number of pieces of candidate information is divided by N: number obtained by adding 1 to the quotient when the remainder is present), and the process returns to step S30 when the group identification information after the value is changed is equal to or less than the number of groups (step S110: No).

When the group identification information after the value is changed exceeds the number of groups (step S110: Yes), the group identification information output unit 120 causes the address providing unit 160 to perform an address setting process. Specifically, the address providing unit 160 provides addresses (for example, DMX address) different from each other to each of pieces of device identification information which are stored by the address storage unit 150 (step S120).

Thereafter, the address output unit 170 of the master control unit 10 sequentially outputs the pieces of device identification information which are stored by the address storage unit 150, as the address setting command, to the signal line 30, in association with addresses corresponding to the pieces of device identification information (step S130). When the device identification information within the address setting command received from the signal line 30 is coincident with the device identification information which is stored by the device identification information storage unit 210, the address setting unit 260 of the device 20 stores an address corresponding to the device identification information within the address setting command, likewise, in the device identification information storage unit 210 (step S132).

When the address output unit 170 of the master control unit 10 finishes outputting all the pieces of device identification information which are stored by the address storage unit 150, to the signal line 30 together with the addresses, the address output unit 170 outputs the address automatic setting mode termination command to the signal line 30 (step S140). When the address automatic setting mode termination command flows through the signal line 30, the control unit 22 terminates the address setting process.

Meanwhile, the address providing unit 160 may allocate an address to device identification information at a timing when the device identification information is stored in the address storage unit 150 and store the resultant in the address storage unit 150.

As described above, according to the present embodiment, a plurality of pieces of candidate information capable of serving as device identification information are divided into a plurality of groups in advance. Each of the plurality of groups is provided with group identification information. The master control unit 10 sequentially outputs pieces of group identification information to the signal line 30. When the group identification information of the belonging group of the device 20 flows through the signal line 30, the control unit 22 of the device 20 outputs the device identification information which is stored by the control unit 22, to the signal line 30. In this case, after the group identification information is received and then a standby time has elapsed, the control unit 22 outputs the device identification information. The standby time is set on the basis of the order of the device identification information of the device 20 within the belonging group. Therefore, a plurality of pieces of device identification information are not output to the signal line 30 simultaneously. Therefore, the master control unit 10 can efficiently acquire the device identification information of the device 20 which is connected to the signal line 30.

In addition, the master control unit 10 outputs the group identification information to the signal line 30. For this reason, the number of times that the master control unit 10 outputs the identification information to the signal line 30 becomes smaller than the number of times that the device identification information is output. Therefore, a time required for acquiring the device identification information of the device 20 which is connected to the signal line 30 is short. For this reason, a time required for setting an address in the control unit 22 is short.

In addition, when a serial number is used as the device identification information, it is not necessary for a user to set the device identification information in the device 20. In addition, in this case, the group identification information may be set to the quotient when the device identification information of the device 20 is divided by N, and thus a standby time may be set to a value obtained by multiplying a constant and the remainder together. In this case, it is possible to easily calculate the group identification information and the standby time.

### Example 1

When a plurality of devices 20 having the same group identification information are present, there is a concern that the count value of the timer 240 of one device 20 reaches the standby time and then device identification information is transmitted while the other device 20 transmits the device identification information. In this case, there is a concern that the master control unit 10 may not be able to receive the device identification information of the device 20 transmitted later. Consequently, the control system 100 according to the present example adds a time required for this process to the time-out period of the master-side timer 130 of the master control unit 10 and the standby time of the control unit 22 of the device 20.

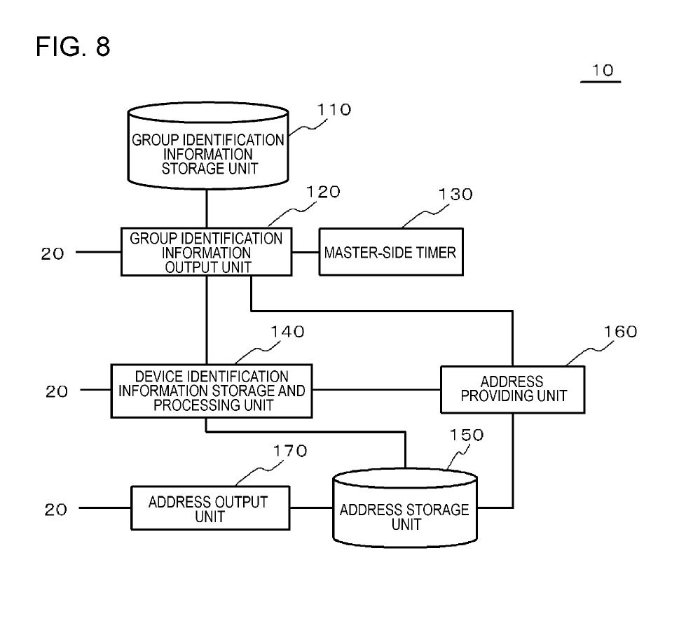

FIG. 8 is a diagram illustrating a functional configuration of a master control unit 10 according to the present example. The master control unit 10 according to the present example has the same configuration as that of the master control unit 10 according to the embodiment, except that the device identification information storage and processing unit 140 notifies the group identification information output unit 120 that the device identification information has been received.

Meanwhile, the functional configuration of the control unit 22 of the device 20 is the same as that in the embodiment in the block diagram.

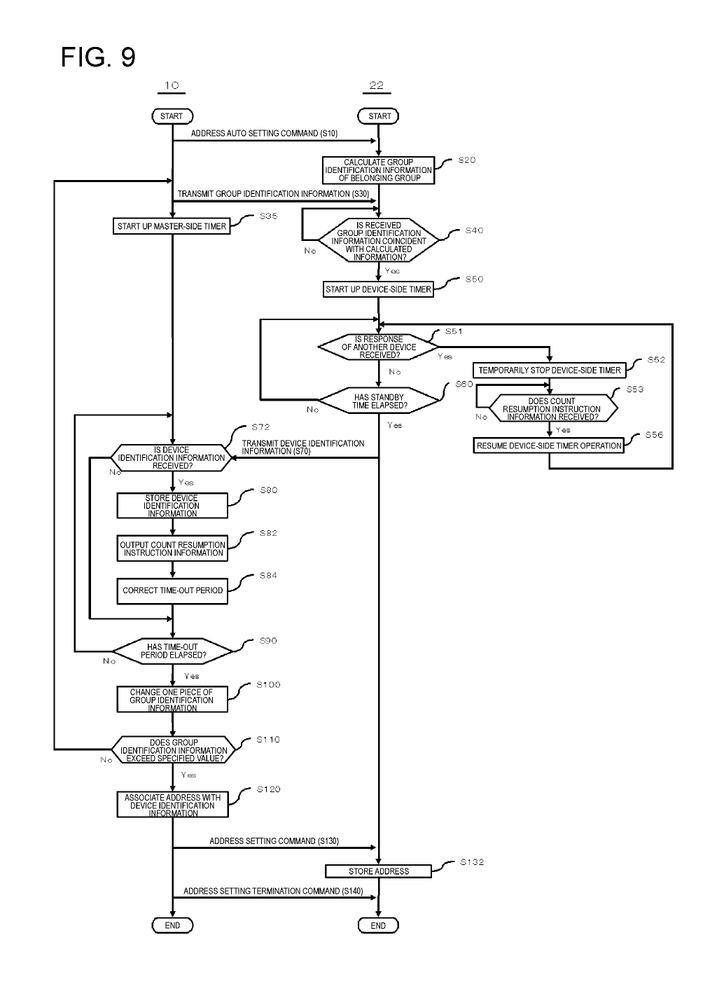

FIG. 9 is a flow diagram illustrating an operation of a control system 100 according to the present example. The drawing is the same as the flow diagram shown in FIG. 7, except for the following points.

First, after the device-side timer 240 of the control unit 22 starts up, when the device identification information is output to the signal line 30 from another control unit 22 (step S51: Yes), the group determination unit 230 of the control unit 22 temporarily stops the device-side timer 240 (step S52). The master control unit 10 then outputs a signal (count resumption instruction information), indicating that a process of storing the device identification information in the address storage unit 150 is terminated, to the signal line 30, and when the count resumption instruction information is acquired from the signal line 30 (step S53: Yes), the operation of the device-side timer 240 is restarted (step S56).

In addition, when the device identification information storage and processing unit 140 has received the device identification information (step S72: Yes), the group identification information output unit 120 of the master control unit 10 outputs the count resumption instruction information to the signal line 30 and outputs a signal indicating the reception of the device identification information to the group identification information output unit 120, when the received device identification information is stored in the address storage unit 150 (step S80). When the information is received, the group identification information output unit 120 adds a preset time (time for receiving the device identification information) to the time-out period (step S84).

In the present example, it is also possible to obtain the same effect as that in the embodiment. In addition, a time necessary for the master control unit 10 to receive a device identification signal is added to the time-out period of the master-side timer 130 of the master control unit 10. In addition, in a period when the device identification information is output from another control unit 22, the device-side timer 240 is temporarily stopped, and the standby time of the control unit 22 of the device 20 is not influenced. Therefore, the master control unit 10 can fetch the device identification information of the device 20 more reliably.

### Example 2

When the same number of device identification signals as the number of devices 20 which are connected to the signal line 30 is stored in the address storage unit 150, a process of acquiring the device identification signal after that becomes useless. In the present example, such uselessness is eliminated.

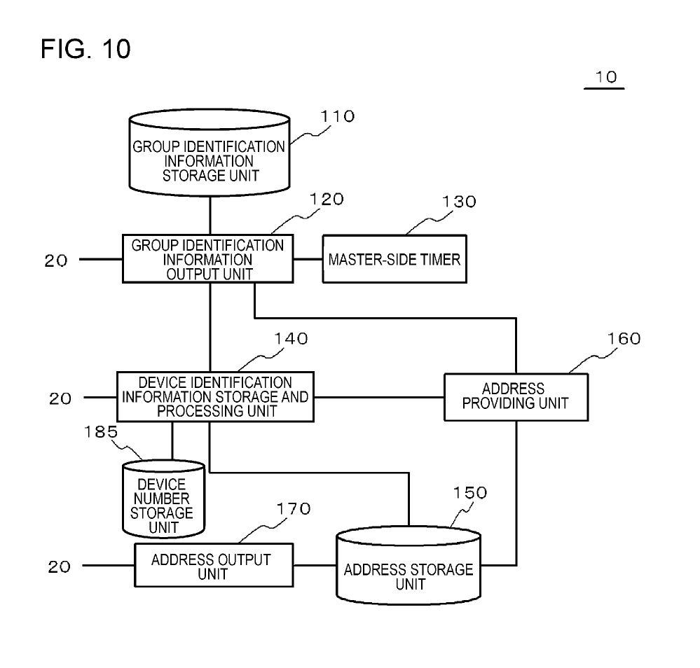

FIG. 10 is a diagram illustrating a functional configuration of a master control unit 10 according to the present example. The master control unit 10 according to the present example has the same configuration as that of the master control unit 10 shown in FIG. 8, except that a device number storage unit 185 is included therein.

The device number storage unit 185 stores the number of plural devices 20 which are connected to the signal line 30. When the number of pieces of device identification information which is stored by the address output unit 170 reaches the number of devices which is stored by the device number storage unit 185, the device identification information storage and processing unit 140 terminates a process of storing the device identification information in the address storage unit 150.

Meanwhile, the functional configuration of the control unit 22 of the device 20 is the same as that in the embodiment in the block diagram.

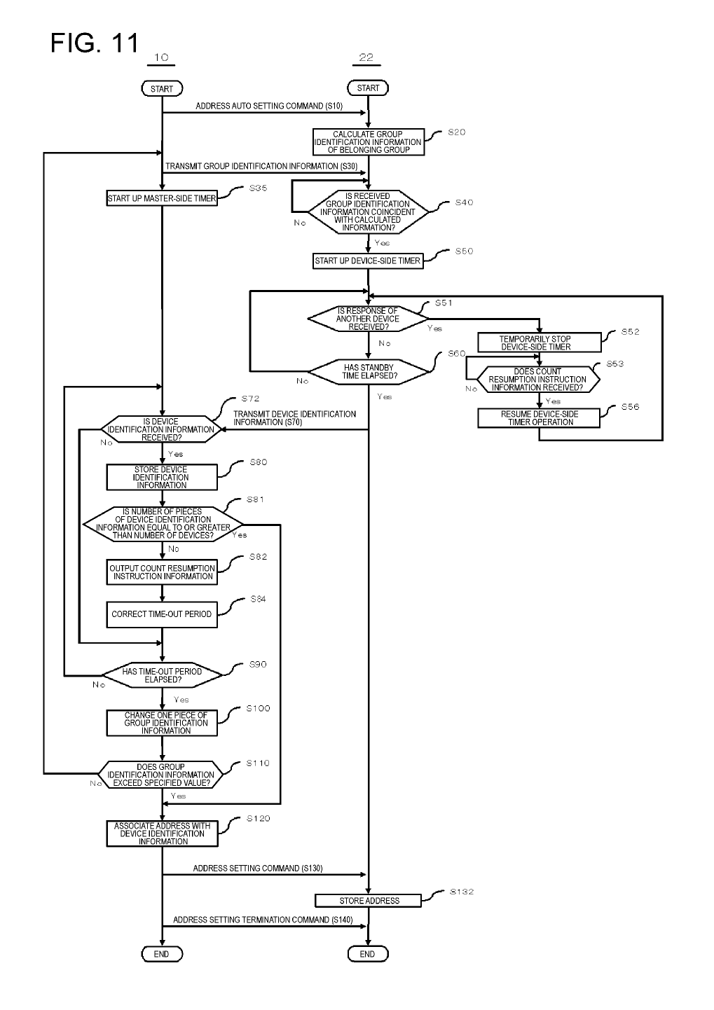

FIG. 11 is a flow diagram illustrating an operation of a control system 100 according to the present example. The drawing is the same as the flow diagram shown in FIG. 9, except for the following points.

First, the device identification information storage and processing unit 140 of the master control unit 10 stores a count value. The initial value of this count value is 0. When the device identification information is stored in the address storage unit 150, the device identification information storage and processing unit 140 increases the count value by one. When the count value is equal to or greater than a number which is stored in the device number storage unit 185 (step S81: Yes), the process termination information output unit 180 outputs an address setting command (process termination information) to a plurality of devices 20 through the signal line 30 (step S130).

In the present example, it is also possible to obtain the same effect as that in the embodiment. In addition, when the same number of device identification signals as the number of devices 20 which are connected to the signal line 30 is stored in the address storage unit 150, the device identification information storage and processing unit 140 terminates a process of acquiring the device identification information. For this reason, a time required for acquiring the device identification information of the device 20 which is connected to the signal line 30 becomes shorter. Therefore, a time required for setting an address in the control unit 22 becomes shorter.

### Example 3

In Examples 1 and 2, the count resumption of the control-side timer of the control unit 22 of the device 20 is performed by a count resumption instruction command from the master control unit 10. However, a time for transmitting the count resumption instruction command becomes needless. In the present example, such uselessness is eliminated.

The configuration of the control unit 22 of the device 20 is the same as that in the embodiment in the block diagram.

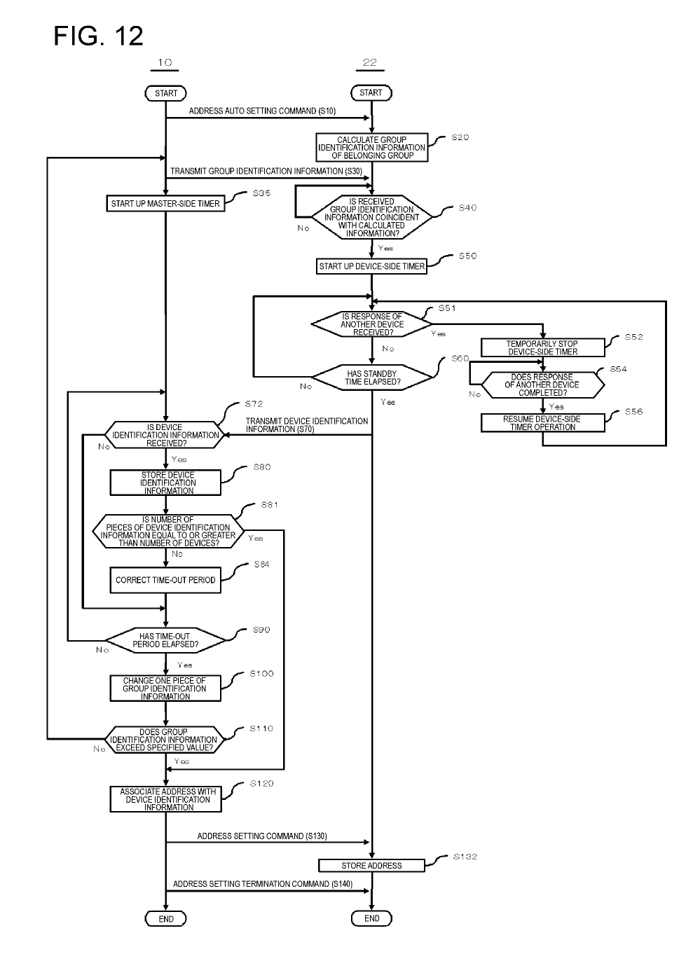

FIG. 12 is a flow diagram illustrating an operation of a control system 100 according to the present example. The drawing is the same as the flow diagram shown in FIG. 9, except for the following points.

In the master control unit 10, steps are performed up to a process shown in step S80. Thereafter, when the device identification information is stored in the address storage unit 150, the device identification information storage and processing unit 140 of the master control unit 10 proceeds to the correction (S84) of a time-out period without outputting the count resumption instruction information (step S82 in FIG. 11).

In addition, in the device 20, the control unit 22 receives a response from another device 20 (step S51: Yes), temporarily stops counting of the device-side timer 240 (step S52), and then restarts counting of the device-side timer 240, when the completion of the transmission of the device identification information by another device 20 is detected (step S54: Yes).

In the present example, it is also possible to obtain the same effect as that in the embodiment. In addition, since the counting of the device-side timer is resumed by detecting the transmission completion of the device identification information of another device 20, the period of time becomes shorter by a time required for transmitting the count resumption instruction information than in Example 2. Therefore, a time required for setting an address in the control unit 22 becomes shorter.

As described above, although the embodiments and examples have been set forthwith reference to the accompanying drawings, they are merely illustrative of the present invention, and various configurations other than those stated above may be adopted.

1. A control system comprising:
a plurality of devices; and
a master control unit that generates control data for the plurality of devices,
wherein each of the plurality of devices is provided with device identification information, in advance, selected from a plurality of pieces of candidate information capable of serving as identification information so as to be different from each other,
the plurality of pieces of candidate information are divided into a plurality of groups in advance,
each of the plurality of groups is provided with group identification information in advance, and
the master control unit includes a group identification information output unit that outputs the plurality of pieces of group identification information sequentially, at intervals of time, to the plurality of devices,
each of the devices includes
a device identification information storage unit that stores the device identification information of the device,
a specific information storage unit that stores belonging group specification information for specifying the group identification information of a belonging group which is the group including the device identification information of the device, from the device identification information of the device,
a group determination unit that determines whether the group identification information which is output from the master control unit corresponds to the belonging group on the basis of the device identification information and the belonging group specification information of the device, and
a device identification information output unit that outputs the device identification information to the master control unit, after an elapse of standby time which is set on the basis of the order of the device identification information of the device within the belonging group, when the group identification information which is output from the master control unit corresponds to the belonging group,
the master control unit further includes
an address providing unit that provides addresses different from each other to the device identification information which are transmitted from each of the plurality of devices,
an address storage unit that stores the plurality of pieces of device identification information in association with the addresses, and
an address output unit that outputs the device identification information and the address in association with each other to each of the devices, and
each of the devices further includes an address setting unit that performs, when the address is transmitted in association with the device identification information which is stored by the device identification information storage unit of the device, a process of storing the address.

2. The control system according to claim 1, wherein the device identification information is a serial number which is provided at the time of shipment of each of the devices.

3. The control system according to claim 2, wherein when the number of pieces of candidate information belonging to one of the groups is set to N, the group identification information of the belonging group of the device is a quotient when the device identification information of the device is divided by N, and
the standby time is a time obtained by multiplying a constant and a remainder when the device identification information of the device is divided by N together.

4. The control system according to claim 1, wherein each of the plurality of devices includes a device-side timer,
the device identification information output unit of the device determines whether the standby time has elapsed on the basis of a count value of the device-side timer, and
the device-side timer starts counting from an initial value when the group identification information of the belonging group is received, and temporarily stops counting when any of the devices outputs the device identification information to the master control unit.

5. The control system according to claim 4, wherein the device-side timer temporarily stops counting, and then restarts counting when any of the devices completes the output of the device identification information to the master control unit.

6. The control system according to claim 4, wherein when the address storage unit of the master control unit stores the device identification information, count resumption instruction information is output to the plurality of devices, and
when the count resumption instruction information is received, the device-side timer which temporarily stops counting restarts counting.

7. The control system according to claim 1, wherein the master control unit includes:
a device number storage unit that stores the number of plural devices, and
a device identification information storage and processing unit terminates a process of storing the device identification information in the address storage unit, when the number of pieces of device identification information stored by the address storage unit reaches the number of devices stored by the device number storage unit.

8. The control system according to claim 1, wherein the device is a light-emitting module.
